(19) United States
(12) Patent Application Publication
(10) Pub. No.: US 2026/0116542 A1
(43) Pub. Date: Apr. 30, 2026

(54) ANGLE ADJUSTABLE AIRCRAFT PASSENGER SEAT ASSEMBLY

(71) Applicant: AMI Industries, Inc., Colorado Springs, CO (US)

(72) Inventors: Arjun Koustubhan, Hyderabad (IN); Sambasiva Kodati, Vinjaram (IN); Dipti Singhvi, Hyderabad (IN); Chad Pacheco, Colorado Springs, CO (US)

(21) Appl. No.: 19/360,352

(22) Filed: Oct. 16, 2025

(30) Foreign Application Priority Data
Oct. 30, 2024 (IN) 202411083535

(51) Int. Cl. B64D 11/06

(52) U.S. Cl. CPC B64D 11/064; B64D 11/0648

(57) ABSTRACT

An aircraft passenger seat assembly includes a frame subassembly mounted on a base subassembly. The frame subassembly interfaces with the base subassembly through a plurality of position adjustable receivers configured to adjust an angle of the frame assembly relative to the base assembly. In embodiments, the positions of the receivers are reconfigurable to provide a particular fixed seat angle at the time of installation of the passenger seat assembly in an aircraft. The base subassembly may be implemented as a frame assembly or a plinth permitting the frame subassembly to be mounted forward or aft facing. In embodiments, the frame subassembly defines a motion path for a seat pan movably mounted to the frame subassembly.

### CROSS REFERENCE TO RELATED APPLICATION

This nonprovisional application claims the benefit of priority of Indian Provisional Application No. 202411083535 filed October 30, 2024, which is hereby incorporated by reference in its entirety.

### TECHNICAL FIELD AND BACKGROUND

The present disclosure relates generally to aircraft passenger seats, and more particularly, to an aircraft passenger seat with provisions for adjustability in terms of facing angle and forward/aft orientation.

Aircraft passenger seats may be capable of various dynamic adjustments during use of the seat. For example, passenger seats in commercial airliners may be adjustable in terms of sitting position, whereas passenger seats in private aircraft may be adjustable in terms of both sitting position and facing angle (i.e., relative to the aircraft longitudinal axis). In private aircraft, seat angle may be dynamically adjustable using a swivel mechanism. In commercial airliners, the facing angle (e.g., forward or oblique) and facing orientation (e.g., forward or aft) of a seat is fixed considering the certification requirements for passenger seats not applicable to passenger seats in private aircraft.

Commercial carriers may desire different facing angles and facing orientations for different cabin configurations. For example, one commercial carrier may desire a particular facing angle and facing orientation for a cabin configuration, whereas the same or another commercial carrier may desire different facing angles and facing orientations within the same cabin configuration. Currently, there is no passenger seat structure including provisions for changing the facing angle and facing orientation at the time of seat installation. Thus, a unique seat structure is required for each different facing angle and facing orientation.

Therefore, to achieve flexibility and customizability in commercial aircraft passenger cabins, what is needed is a universal seat structure including primary load path components that can be reconfigured to change the facing angle and facing orientation of the passenger seat.

### BRIEF SUMMARY

According to one aspect, the inventive concepts according to the present disclosure are directed to an aircraft passenger seat assembly including provisions for changing at least one of facing angle and facing orientation. In embodiments, the passenger seat assembly includes a base subassembly configured to mount to a floor in an aircraft cabin and including first receivers and second receivers, a frame subassembly mounted on the base subassembly and including a first spreader and a second spreader, wherein the first spreader interfaces with the first receivers, the second spreader interfaces with the second receivers, the first receivers are position adjustable to change an angle of the first spreader, and the second receivers are position adjustable to change an angle of the second spreader.

In some embodiments, the frame subassembly includes at least one transverse frame member coupled between the first spreader and the second spreader, and each of the first and second spreaders includes at least one non-linear slot defining a motion path for a seat pan configured to be movably mounted to the frame subassembly.

In some embodiments, the base subassembly includes at least two legs, at least two transverse beams coupled to the at least two legs, first spacer frames translatably mounted to the at least two transverse beams, wherein the first spacer frames are position adjustable along a length the at least two transverse beams, and wherein the first receivers are disposed in the first spacer frames, and second spacer frames translatably mounted to the at least two transverse beams, wherein the second spacer frames are position adjustable along the length of the at least two transverse beams, and wherein the second receivers are disposed in the second spacer frames.

In some embodiments, each of the first spacer frames includes at least two of the first receivers, and each of the second spacer frames includes at least two of the second receivers.

In some embodiments, movement of the first spacer frames farther apart corresponds to increasing the angle of the first spreader, movement of the first spacer frames closer together corresponds to decreasing the angle of the first spreader, movement of the second spacer frames farther apart corresponds to increasing the angle of the second spreader, and movement of the second spacer frames closer together corresponds to decreasing the angle of the first spreader.

In some embodiments, when the frame subassembly is angled relative to the base subassembly, the first spreader interfaces with two of the first receivers in adjacent ones of the first spacer frames, and the second spreader interfaces with two of the second receivers in adjacent ones of the second spacer frames.

In some embodiments, the first spreader includes first downwardly extending fasteners configured to engage in the first receivers, wherein at least one of the first downwardly extending fasteners is position adjustable along a length of the first spreader, and the second spreader includes second downwardly extending fasteners configured to engage in the second receivers, wherein at least one of the second downwardly extending fasteners is position adjustable along a length of the second spreader.

In some embodiments, the base subassembly includes a plinth defining first elongated slots and second elongated slots, wherein the first receivers are disposed in the first elongated slots and the second receivers are disposed in the second elongated slots, first clevis assemblies configured to couple the first spreader to the first receivers, and second clevis assemblies configured to couple the second spreader to the second receivers.

In some embodiments, the first elongated slots include a first linear slot and a second linear slot oriented orthogonal to the first linear slot, and the second elongated slots include a first linear slot and a second linear slot oriented orthogonal to the first linear slot.

In some embodiments, the first receivers and the second receivers are implemented as locking plates mounted between jammer plates, a length of the jammer plates determines a position of the locking plates within their respective one of the first elongated slots and the second elongated slots, the first clevis assemblies are configured to interface with the locking plates mounted in the first elongated slots, and the second clevis assemblies are configured to interface with the locking plates mounted in the second elongated slots.

In some embodiments, at least some of the first and second clevis assemblies include a height-increasing riser.

According to another aspect, the present disclosure is directed to an aircraft passenger seat assembly including a base subassembly configured to mount to a floor in an aircraft cabin, a frame subassembly mounted on the base subassembly, and a seat support subassembly movably mounted to the frame subassembly, wherein the frame subassembly and the base subassembly interface through receivers that are position adjustable to change an angle of the frame subassembly relative to the base subassembly.

In some embodiments, the receivers include spacer frames translatably mounted to the base subassembly, and the frame subassembly includes spreaders configured to mount to the spacer frames.

In some embodiments, the spacer frames are symmetrical and are symmetrically arranged on the base subassembly such that the frame subassembly can be mounted on the base subassembly in a forward facing orientation or an aft facing orientation.

In some embodiments, the base subassembly is a plinth, the receivers include locking plates disposed in elongated slots formed in the plinth, and the frame subassembly includes clevis assemblies configured to mount to the locking plates.

In some embodiments, each locking plate is constrained between two jammers, and a length of each of the two jammers determines a position of each locking plate relative to its respective elongated slot.

According to a further aspect, the present disclosure is directed to an aircraft passenger seat assembly including a base subassembly, and a frame subassembly mounted to the base subassembly, wherein the frame subassembly interfaces with the base subassembly through position adjustable receivers on the base subassembly, and a position of the receivers is configured to be set at installation of the passenger seat assembly in an aircraft and is not dynamically adjustable during use of the passenger seat assembly.

### BRIEF DESCRIPTION OF THE DRAWINGS

Implementations of the inventive concepts disclosed herein may be better understood when consideration is given to the following detailed description thereof. Such description refers to the included drawings, which are not necessarily to scale, and in which some features may be exaggerated and some features may be omitted or may be represented schematically in the interest of clarity. Like reference numerals in the drawings may represent and refer to the same or similar element, feature, or function. In the drawings:

FIG. 1 is a front isometric view of an aircraft passenger seat assembly illustrating a first facing angle, in accordance with example embodiments of this disclosure;

FIG. 2 is a partially exploded view of the aircraft passenger seat assembly illustrating a first embodiment of a base subassembly, in accordance with example embodiments of this disclosure;

FIG. 3 is a detailed view of FIG. 2 illustrating the interface between the base subassembly and a frame subassembly, in accordance with example embodiments of this disclosure;

FIG. 4 is a detailed view of FIG. 2 illustrating receivers disposed in spacer frames of the base subassembly, in accordance with example embodiments of this disclosure;

FIG. 5 is a front isometric view of the aircraft passenger seat assembly illustrating a second facing angle, in accordance with example embodiments of this disclosure;

FIG. 6 is a front isometric view of the aircraft passenger seat assembly further including backrest supports for aft facing seat orientations, in accordance with example embodiments of this disclosure;

FIG. 7 is a front isometric view of the aircraft passenger assembly further including a seat support subassembly shown in an upright sitting position, in accordance with example embodiments of this disclosure;

FIG. 8 is a front isometric view of the aircraft passenger seat assembly illustrating the seat support subassembly shown in a lie flat sleeping position, in accordance with example embodiments of this disclosure;

FIG. 9 is an exploded view of the aircraft passenger seat assembly illustrating a second embodiment of the base subassembly, in accordance with example embodiments of this disclosure;

FIG. 10 is an exploded side elevation view of the aircraft passenger seat assembly illustrating the interface between the frame subassembly and the base subassembly, in accordance with example embodiments of this disclosure;

FIG. 11 is a side elevation view of the aircraft passenger seat assembly including the second embodiment of the base subassembly and shown in an aft facing orientation, in accordance with example embodiments of this disclosure;

FIG. 12 is a side elevation view of the aircraft passenger seat assembly including the second embodiment of the base subassembly and shown in a forward facing orientation, in accordance with example embodiments of this disclosure;

FIG. 13 is a detailed view of a clevis assembly for use with the second embodiment of the base subassembly, in accordance with example embodiments of this disclosure; and

FIG. 14 is a detailed view of the second embodiment of the base subassembly illustrating the interface between the base subassembly and the frame subassembly.

### DETAILED DESCRIPTION

Before explaining at least one embodiment of the inventive concepts disclosed herein in detail, it is to be understood that the inventive concepts are not limited in their application to the details of construction and the arrangement of the components or steps or methodologies set forth in the following description or illustrated in the drawings. In the following detailed description of embodiments of the instant inventive concepts, numerous specific details are set forth in order to provide a more thorough understanding of the inventive concepts. However, it will be apparent to one of ordinary skill in the art having the benefit of the instant disclosure that the inventive concepts disclosed herein may be practiced without these specific details. In other instances, well-known features may not be described in detail to avoid unnecessarily complicating the instant disclosure. The inventive concepts disclosed herein are capable of other embodiments or of being practiced or carried out in various ways. Also, it is to be understood that the phraseology and terminology employed herein is for the purpose of description and should not be regarded as limiting.

As used herein, a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only, and should not be construed to limit the inventive concepts disclosed herein in any way unless expressly stated to the contrary.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of embodiments of the instant inventive concepts. This is done merely for convenience and to give a general sense of the inventive concepts, and “a” and “an” are intended to include one or at least one and the singular also includes the plural unless it is obvious that it is meant otherwise.

Finally, as used herein any reference to “one embodiment” or “some embodiments” means that a particular element, feature, structure, or characteristic described in connection with the embodiment is included in at least one embodiment of the inventive concepts disclosed herein. The appearances of the phrase “in some embodiments” in various places in the specification are not necessarily all referring to the same embodiment, and embodiments of the inventive concepts disclosed may include one or more of the features expressly described or inherently present herein, or any combination of sub-combination of two or more such features, along with any other features which may not necessarily be expressly described or inherently present in the instant disclosure.

Broadly, this disclosure describes an aircraft passenger seat assembly reconfigurable in terms of facing angle and/or facing orientation. As used herein, the term “facing angle” refers to the occupant facing direction relative to the aircraft longitudinal axis determined by the angle of the frame subassembly described herein. Facing angles may include, but are not limited to, forward facing and oblique facing. Known to those skilled in the art, forward facing seats for transport aircraft are classified as a having an angle from 0 degrees to no greater than 18 degrees, and oblique facing seats are classified as having an angle greater than 18 degrees and no greater than 45 degrees. As used herein, the term “facing orientation” refers to the occupant facing direction with respect to the front and rear of the aircraft determined by the facing direction of the frame subassembly. Facing orientations according to the present disclosure include, for example, forward facing and aft facing. Performance criteria are also defined for the different facing directions of a passenger seat.

The aircraft passenger seat assembly according to the present disclosure generally includes three primary subassemblies, and more specifically, a base subassembly configured to mount to a floor in an aircraft, a frame subassembly configured to mount on or to the base subassembly, and a passenger support subassembly configured to movably mount to the frame subassembly. The base subassembly, the frame subassembly, and their interface are described herein in detail. The passenger support subassembly for supporting the occupant generally includes a seat pan, a backrest, and an optional leg rest that may vary in terms of design, motion path, adjustability, and customization. The base subassembly and the frame subassembly interface via provisions that provide the ability to change the facing angle and facing orientation of the frame subassembly relative to the base subassembly. In contrast to traditional passenger seats for private aircraft that may be capable of changing angle and direction during use of the seat (e.g., via a swivel mechanis), the adjustment provisions according to the present disclosure are intended to fix the facing angle and facing orientation at the time of seat installation, or reinstallation in the event of a cabin reconfiguration. In other words, the provisions for adjusting the facing angle and facing orientation do not allow for dynamic adjustments by the occupant during use of the seat.

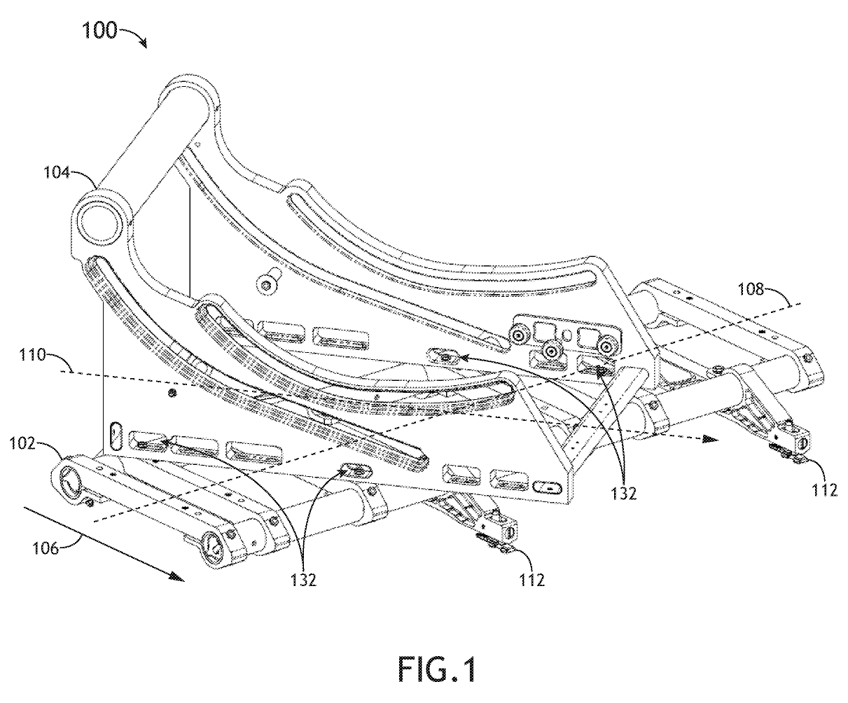

FIG. 1 illustrates the aircraft passenger seat assembly 100 generally including a base subassembly 102 and a frame subassembly 104 mounted on the base subassembly 102. The base subassembly 102 and the frame subassembly 104 interface via provisions that allow the frame subassembly 104 to be adjusted relative to the base subassembly 102 in terms of angle and orientation without changing the primary load path components. For example, directional arrow 106 indicates the forward direction and angle of the aircraft longitudinal axis, reference line 108 indicates the lateral axis of the base subassembly 102, and directional arrow 110 indicates the facing angle and orientation of the frame subassembly 104. As shown, the provisions of the base subassembly 102 for adjusting the facing angle and orientation are oriented parallel or substantially parallel to the aircraft longitudinal axis 106, and the frame subassembly 104 is positioned at an oblique forward facing angle.

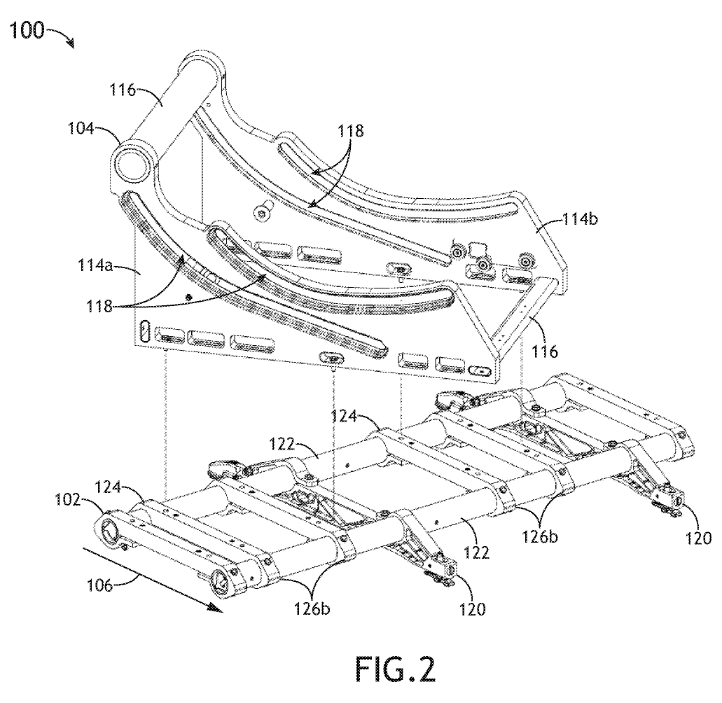

FIG. 2 illustrates the frame subassembly 104 detached from the base subassembly 102 for clarity. The base subassembly 102 is configured to mount to the aircraft floor. In embodiments, the base subassembly 102 may include traditional track fasteners 112 configured to mount to seat tracks in the floor. In embodiments, the frame subassembly 104 generally includes a first spreader 114a (e.g., right spreader) and a second spreader 114b (e.g., left spreader), which are primary load path components. In embodiments, at least one transverse beam 116 is coupled between the upstanding first and second spreaders 114a, 114b. As shown, a first transverse beam 116 is positioned at the ‘aft’ end of the frame subassembly 104 and a second transverse beam 116 is positioned at the ‘forward’ end of the frame subassembly 104. In embodiments, each of the first and second spreaders 114a, 114b includes at least one elongated non-linear slot 118 defining a motion path for a seat pan configured to be movably mounted to the frame subassembly 104. In use, the at least one elongated non-linear slot guides the motion of the seat pan as the passenger support assembly (not shown) transitions between an upright sitting position in preparation for taxi, take-off, and landing (TTOL), and a reclined sitting position such as a lie flat sleeping position, through various intermediate sitting positions. At least one of the number, position, shape, length, etc., of the at least one elongated non-linear slot 118 may vary to provide different motion pathways for the seat pan depending on the configuration, attachment, and desired motion of the seat pan.

The base subassembly 102 may include at least two legs 120 and at least two transverse beams 122 coupled to the at least two legs 120. As shown, the base subassembly includes two legs 120 and two transverse beams 122 implemented as forward and rear beam tubes. The base subassembly 102 further includes a plurality of spacer frames 124 mounted to the at least two transverse beams 122. In embodiments, each spacer frame 124 is translatably mounted to the at least two transverse beams 122 such that the spacer frames 124 can be adjusted “left” or “right.” As shown, the base subassembly 102 includes end spacer frames mounted at the ends of the transverse beams 122, an inner spacer frames mounted between the end spacer frames. In embodiments, two adjacent inner spacer frames 124 are first receivers 126a for interfacing with the first spreader 114a, and two other adjacent inner spacer frames 124 are second receivers 126b for interfacing with the second spreader 114b.

In embodiments, to mount the frame subassembly 104 at an angle (e.g., oblique angle), the first spreader 114a interfaces with both first receivers 126a and the second spreader 114b interfaces with both second receivers 126b. To mount the frame subassembly 104 parallel to the aircraft longitudinal axis 106 (e.g., 0 degrees forward or aft facing orientation), the first spreader 114a may mount to one of the spacer frames 124 and the second spreader may mount to another one of the spacer frames 124. Thus, with the spacer frame configuration shown, the frame subassembly 104 may be angled from 0 degrees up to 45 degrees.

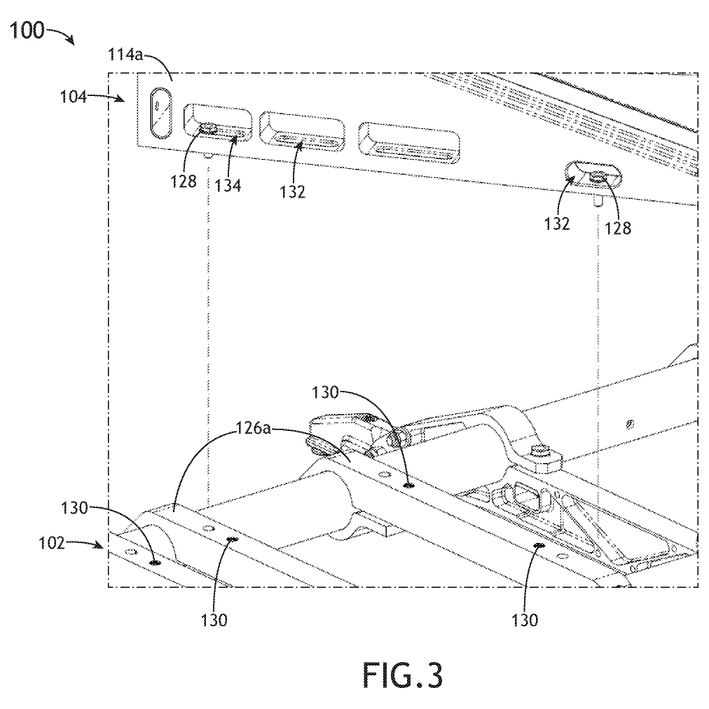

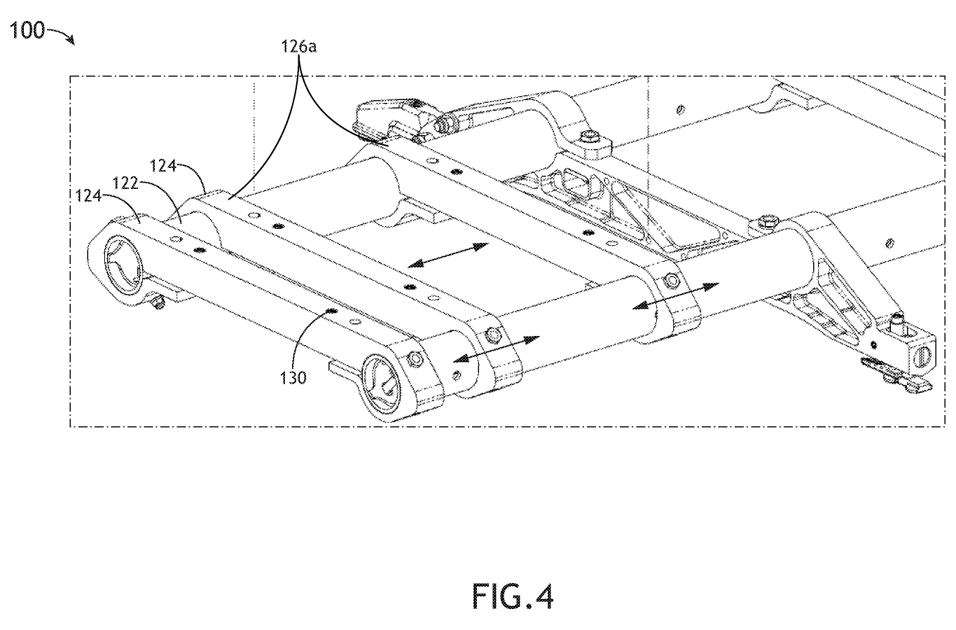

FIGS. 3 and 4 are detailed views of the assembly 100 illustrating the interface between the base subassembly 102 and the frame subassembly 104. In embodiments, the first and second spreaders 114a (114b not shown) include fasteners 128 (e.g., pins, bolts, screws, etc.) that extend downwardly from the bottom of the first and second spreaders 114a, 114b. Each spacer frame 124 includes corresponding openings or thru holes 130 for receiving the fasteners 128 from above. The positions of the spacer frames 124 corresponding to the first receivers 126 and the second receivers 126b are adjustable relative to each other and relative to the at least two transverse beams 122. In this configuration, the first and second receivers 126a, 126b can be translated laterally as a group in one direction or the other to change the lateral position of the frame subassembly 104, and the first receivers 126a and the second receivers 126b are position adjustable relative to each other to change the facing angle of the frame subassembly 104.

Referring to the first receivers 126a by example, the relative position of the two spacer frames 124 can be adjusted to change the facing angle of the first spreader 114a thereby changing the facing angle of the frame subassembly 104. The same applies to the second receivers 126b and the second spreader 114b. To decrease the facing angle (i.e., make the frame subassembly 104 more parallel with the aircraft longitudinal axis 106), the two spacer frames 124 coupled to their respective spreader 114a, 114b are moved (e.g., translated) closer together. To increase the facing angle (i.e., make the frame subassembly 104 less parallel with the aircraft longitudinal axis 106), the two spacer frames 124 coupled to their respective spreader 114a, 114b are moved (e.g., translated) farther apart. In other words, increasing the distance between spacer frame pairings increases the facing angle (i.e., more oblique), whereas decreasing the distance between spacer frame pairings decreases the facing angle (i.e., less oblique).

In embodiments, the frame subassembly 104 and the base subassembly 102 interface at four points of contact, i.e., the first spreader 114a being coupled to two different spacer frames 124 forming the first receivers 126a, and the second spreader 114b being coupled to two different spacer frames 124 forming the second receivers 126b. In embodiments, each spacer frame 124 may include a bolted clamp 132 at opposing ends for clamping around the transverse beams 122. In use, the bolted clamps 132 are tightened to fix their position along the length of the transverse beams 122 and are loosened to allow the spacer frames 124 to slide along the beams. For example, to change the facing angle of the frame subassembly 104, at least one spacer frame 124 coupled to the first spreader 114a and at least one spacer frame 124 coupled to the second spreader 114b are loosed and translated, for instance equidistant and in the same direction. Once positioned to achieve the desired facing angle, all loosened spacer frames 124 are tightened to maintain their position. In some embodiments, to achieve a drastic angle change, it may be necessary not only to adjust the relative positions of the spacer frame pairings, but also shift all spacer frames 124 in one direction or the other.

In embodiments, the spacer frames 124 may define a substantially planar top surface for engaging a substantially planar bottom surface of the first and second spreaders 114a, 114b. A plurality of openings 132 may be formed through the side of the spreaders 114a, 114b, wherein at least some of the openings 132 include an elongated slot 134 for receiving the fasteners 128. The opening 132 used and fastener position along the length of the elongated slot 134 may depend on the facing angle. For example, for each of the first and second spreaders 114a, 114, the fasteners 128 may be spaced closer together for shallower angles (e.g., less oblique) considering the closer spacing of the spacer frames 124, and farther apart for steeper angles (e.g., more oblique) to bridge the gap between the greater spacing of the spacer frames 124. The number and spacing of the openings 132 may vary based on the range of angular adjustment of the frame subassembly 104. In embodiments, some openings 132 may include elongated slots 134 for fastener adjustability whereas other openings may have a thru-hole.

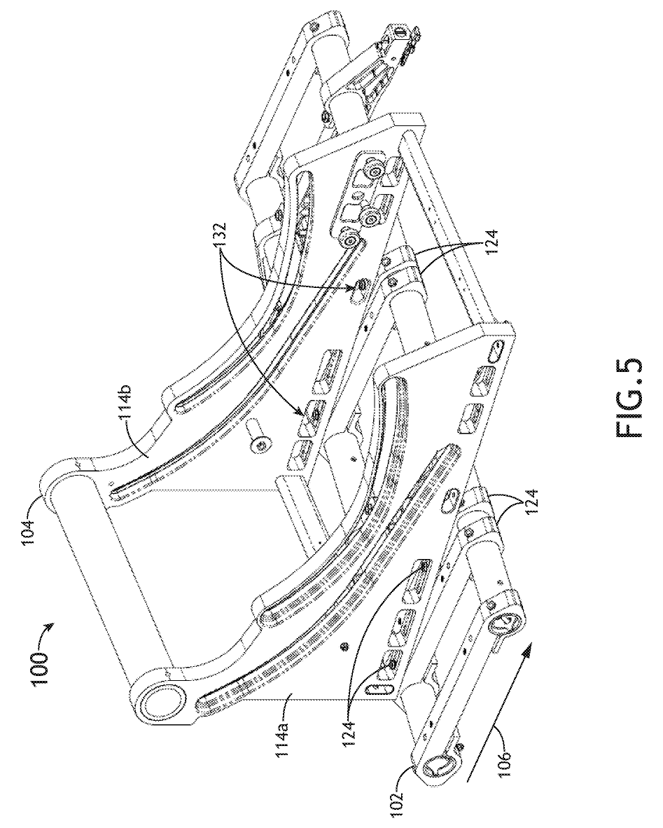

FIG. 5 illustrates the aircraft passenger seat assembly 100 including the same base subassembly 102 and frame subassembly 104 as shown in FIG. 1; however, wherein the facing angle has been adjusted to achieve a less oblique facing angle in which the frame subassembly 104 is oriented closer to parallel with the aircraft longitudinal axis 106. Comparing FIGS. 1 and 5, the spacer frames 124 forming the first and second receivers 126a, 126b are positioned closer together in FIG. 5 to decrease the facing angle, and it can also be seen that the fasteners 128 in FIG. 5 are positioned closer together considering the shorter distance between the spacer frames 124. FIGS. 1 and 5 also show the different openings 132 used on each of the spreaders to attach the frame subassembly 104 considering the spreader positions relative to the base subassembly 102.

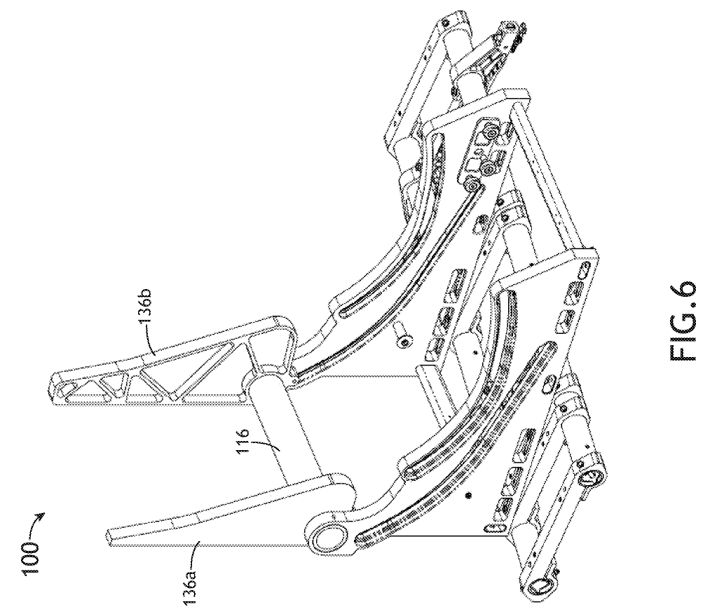

FIG. 6 illustrates the aircraft passenger seat assembly 100 further including additional backrest supports 136a, 136b that may be used to support the backrest when the frame subassembly 104 is oriented aft facing. In embodiments, the backrest supports 136a, 136b may be rotatably mounted to the transverse beam 116 implemented as a beam tube. In use, the backrest supports 136a, 136b may be positioned upright as shown when the sitting position is upright for TTOL and may rotate toward horizontal when the sitting position moves toward lie flat. In embodiments, the rotational motion of the backrest supports 136a, 136b may follow the backrest motion.

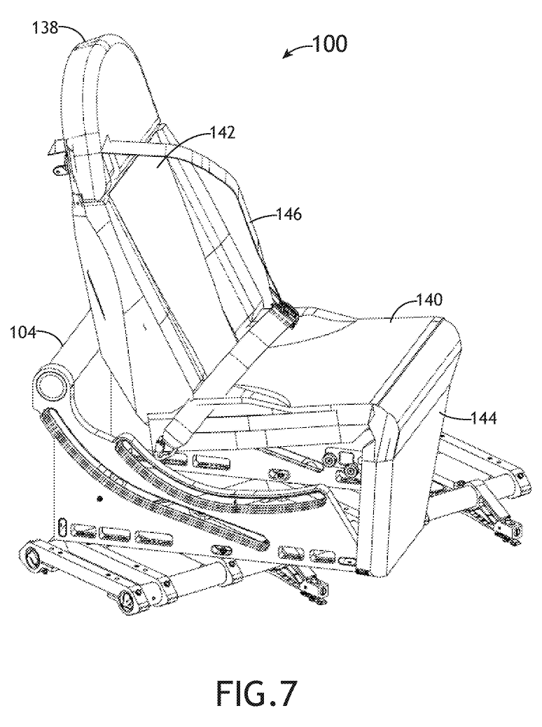

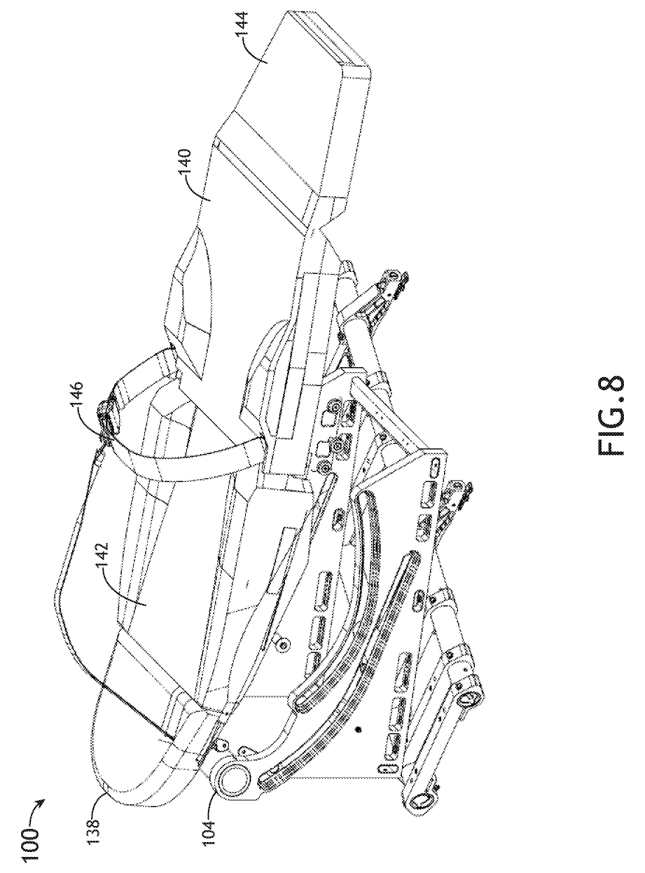

FIGS. 7 and 8 illustrate the respective TTOL sitting position and lie flat sleeping position of the aircraft passenger seat assembly 100. In embodiments, a seat subassembly 138 is movably mounted to the frame subassembly 104. As shown, the seat subassembly 138 includes a seat pan 140, a backrest 142 pivotably coupled to one end of the seat pan 140, and a leg rest 144 pivotably coupled to the opposing end of the seat pan 140. The seat pan 140, backrest 142, and leg rest 144 may be coupled to a seat actuator system configured to transition the seat between the upright sitting position and the lie flat sleeping position through various intermediate positions. Motions of one or more of the seat pa 140, backrest 142, and leg rest 144 may be coupled for synchronous motion wherein the motion of one component may drive the motion of another. The seat subassembly 138 is shown detached from the frame subassembly 104 and without coupling hardware considering the attachment mechanism may vary and is not critical to the angular adjustment capability of the frame subassembly 104, nor is the configuration of the passenger restraint 146.

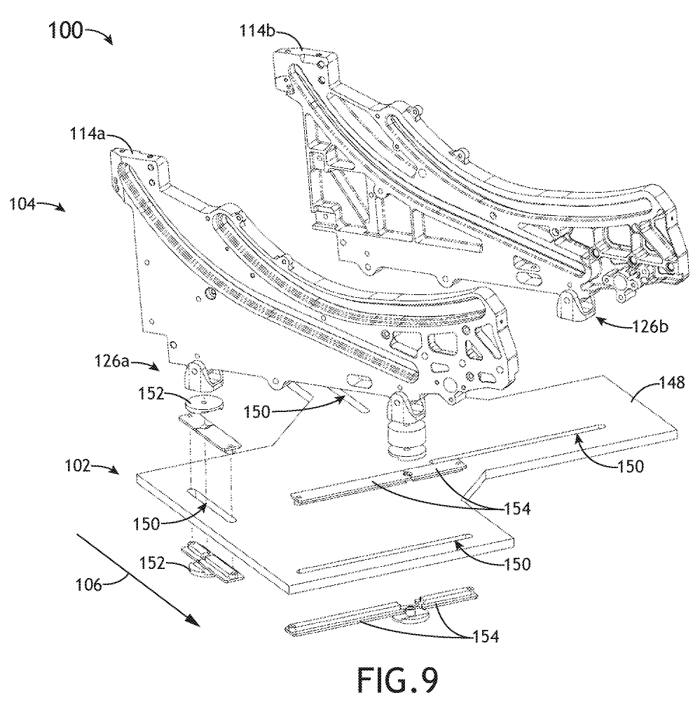

FIG. 9 illustrates the aircraft passenger seat assembly 100 wherein the base subassembly 102 includes a plinth 148 and the first and second spreaders 114a, 114b have a different attachment configuration for mounting the frame subassembly 104 to or on the plinth 148. In embodiments, the plinth 148 is a substantially planar platform configured to mount to the aircraft floor, either directly or indirectly. As shown, the plinth 148 includes elongated slots 150 for receiving the first and second receivers 126a, 126b implemented as locking plates 152. In embodiments, each locking plate 152 includes an upper part and a lower part configured to attach and mount between jammer plates 154 mounted in one of the elongated slots.

The jammer plates 154 may be provided in different lengths such that different combinations of jammer plate lengths can be used to position the locking plates 152 along the length of their respective elongated slot 150. Like the mounting plates 152, the jammer plates 154 may include two parts that attach. The positions of the locking plates 152 determine the angle of the frame subassembly 104. In embodiments, each elongated slot 150 is linear, and each spreader 114a, 114b interfaces with two separate elongated slots 150. As shown, the elongated slots 150 for each spreader are oriented perpendicular and one end of one elongated slot 150 aligns with the other elongated slot 150 to provide a 0-degree facing angle (i.e., parallel to the aircraft longitudinal axis 106). The length of the elongated slots 150 can be customized to define an angular range of adjustability.

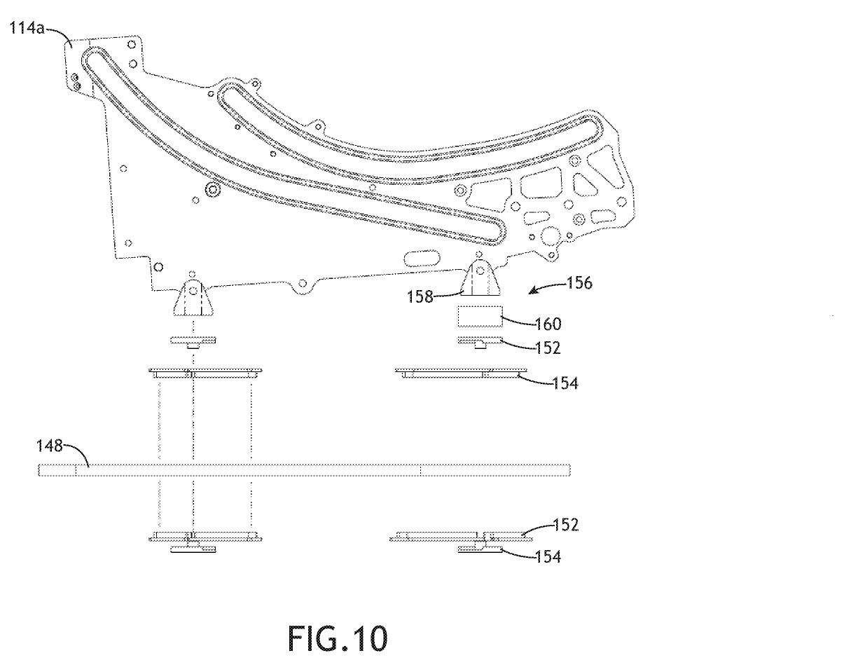

FIG. 10 illustrates the interface between the first spreader 114a and the plinth 148. When assembled, each locking plate 152 is captured between two jammer plates 154 to fix the position of the locking plate 152 along the elongated slot. In embodiments, the locking plates 152 mount to clevis assemblies 156 including a clevis 158 pivotably mounted to the spreader 114a. Although not shown, a bolt or pin may be received through the locking plate 152 and clevis 158 to secure the spreader 114a in place. In some embodiments, to compensate for a slight nose-up angle, the clevis assembly 156 may include a riser 160 positioned between locking plate 152 and the clevis 158. As shown, the clevis assembly 156 at the forward end includes a riser 160 to achieve a full-flat berth for an aft facing orientation.

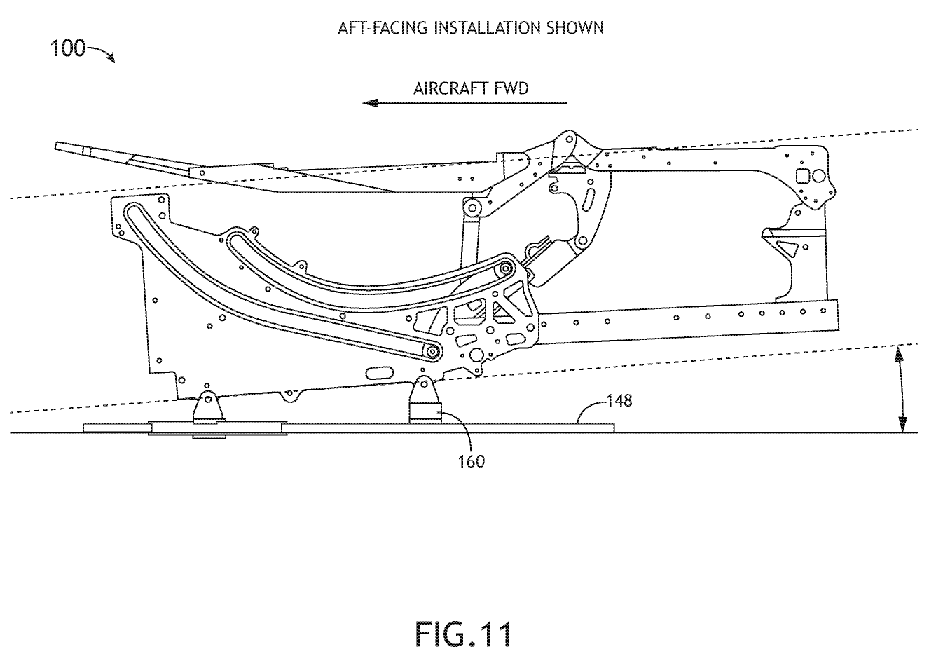

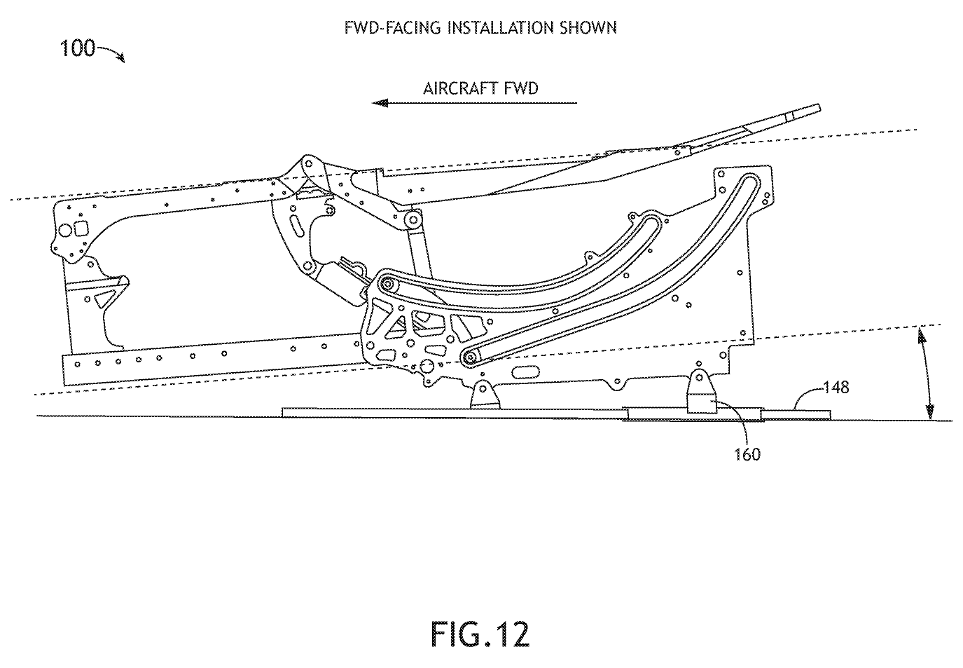

FIG. 11 illustrates the aircraft passenger seat assembly 100 shown installed in an aft facing orientation. In this facing orientation and with a seat capable of achieving a full-flat berth as shown, the forward end of the seat is inclined using risers 160 to compensate for the nose-up angle of the aircraft. In other words, to provide a substantially horizontal sleeping position, the forward end of the seat is installed with a slight incline to compensate for the angle of the plinth 148 when the aircraft is flying nose-up. FIG. 12 illustrates the same aircraft passenger seat assembly 100 installed in a forward facing orientation and with the back end of the seat including using risers 160 to compensate for the nose-up flying condition of the aircraft.

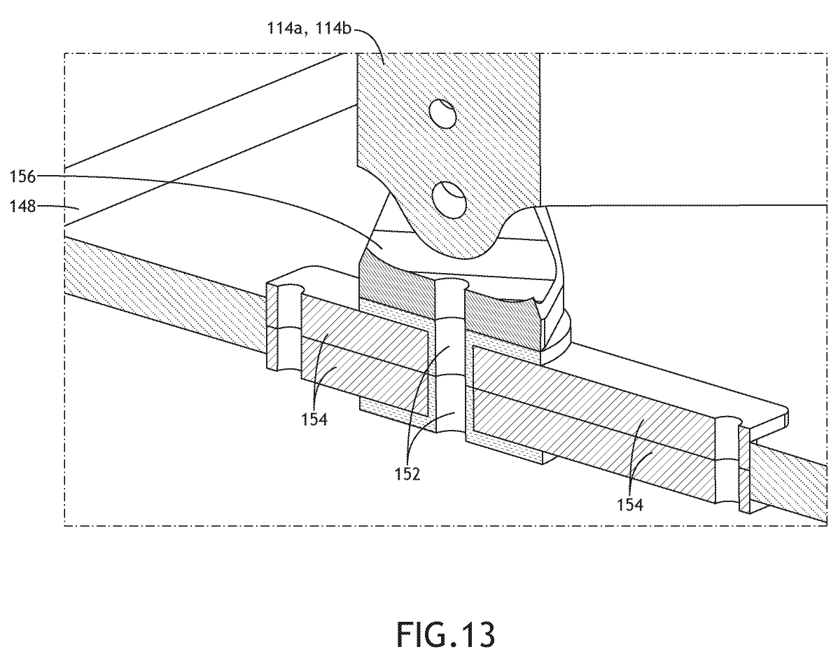

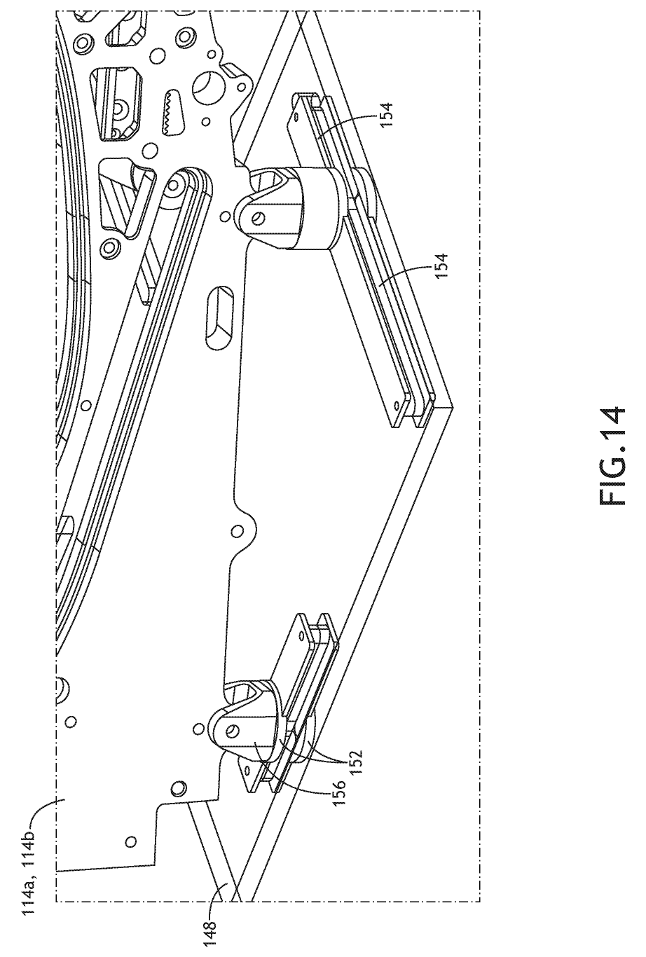

FIG. 13 and 14 illustrate the assembled condition of the interface for mounting the first and second spreaders 114a, 114b to the plinth 148. In embodiments, each of the locking plates 152 and jammer plates 154 are provided in two parts (e.g., halves) that attach and secure together, for instance using a bolt or pin. The clevis 156 may mount directly atop the locking plate 152 when a riser 160 is not used. In embodiments, the locking plates 152 are rotatably fixed relative to the jammer plates 154, whereas the clevis 156 can rotate relative to the locking plates 152. With this configuration, when the positions of the locking plates 152 are changed to adjust the facing angle, the clevis 156 can rotate relative to the rotatably fixed locking plates 152 while remaining coupled to the locking plates 152.

From the above description, it is clear that the inventive concepts disclosed herein are well adapted to achieve the objectives and to attain the advantages mentioned herein as well as those inherent in the inventive concepts disclosed herein. While presently preferred embodiments of the inventive concepts disclosed herein have been described for purposes of this disclosure, it will be understood that numerous changes may be made which will readily suggest themselves to those skilled in the art and which are accomplished within the broad scope and coverage of the inventive concepts disclosed and claimed herein.

What is claimed is:

1. An aircraft passenger seat assembly, comprising:
a base subassembly configured to mount to a floor in an aircraft cabin, the base subassembly including first receivers and second receivers; and
a frame subassembly mounted on the base subassembly, the frame subassembly including a first spreader and a second spreader;
wherein:
the first spreader interfaces with the first receivers and the second spreader interfaces with the second receivers; and
the first receivers are position adjustable to change an angle of the first spreader and the second receivers are position adjustable to change an angle of the second spreader.

2. The aircraft passenger seat assembly according to claim 1, wherein:
the frame subassembly includes at least one transverse frame member coupled between the first spreader and the second spreader; and
each of the first and second spreaders includes at least one non-linear slot defining a motion path for a seat pan configured to be movably mounted to the frame subassembly.

3. The aircraft passenger seat assembly according to claim 1, wherein the base subassembly comprises:
at least two legs;
at least two transverse beams coupled to the at least two legs;
first spacer frames translatably mounted to the at least two transverse beams, wherein the first spacer frames are position adjustable along a length the at least two transverse beams, and wherein the first receivers are disposed in the first spacer frames; and
second spacer frames translatably mounted to the at least two transverse beams, wherein the second spacer frames are position adjustable along the length of the at least two transverse beams, and wherein the second receivers are disposed in the second spacer frames.

4. The aircraft passenger seat assembly according to claim 3, wherein:
each of the first spacer frames includes at least two of the first receivers; and
each of the second spacer frames includes at least two of the second receivers.

5. The aircraft passenger seat assembly according to claim 3, wherein:
movement of the first spacer frames farther apart corresponds to increasing the angle of the first spreader, and movement of the first spacer frames closer together corresponds to decreasing the angle of the first spreader; and
movement of the second spacer frames farther apart corresponds to increasing the angle of the second spreader, and movement of the second spacer frames closer together corresponds to decreasing the angle of the first spreader.

6. The aircraft passenger seat assembly according to claim 3, wherein, when the frame subassembly is angled relative to the base subassembly:
the first spreader interfaces with two of the first receivers in adjacent ones of the first spacer frames; and
the second spreader interfaces with two of the second receivers in adjacent ones of the second spacer frames.

7. The aircraft passenger seat assembly according to claim 1, wherein:
the first spreader includes first downwardly extending fasteners configured to engage in the first receivers, wherein at least one of the first downwardly extending fasteners is position adjustable along a length of the first spreader; and
the second spreader includes second downwardly extending fasteners configured to engage in the second receivers, wherein at least one of the second downwardly extending fasteners is position adjustable along a length of the second spreader.

8. The aircraft passenger seat assembly according to claim 1, wherein the base subassembly comprises:
a plinth defining first elongated slots and second elongated slots, wherein the first receivers are disposed in the first elongated slots and the second receivers are disposed in the second elongated slots;
first clevis assemblies configured to couple the first spreader to the first receivers; and
second clevis assemblies configured to couple the second spreader to the second receivers.

9. The aircraft passenger seat assembly according to claim 8, wherein:
the first elongated slots include a first linear slot and a second linear slot oriented orthogonal to the first linear slot; and
the second elongated slots include a first linear slot and a second linear slot oriented orthogonal to the first linear slot.

10. The aircraft passenger seat assembly according to claim 8, wherein:
the first receivers and the second receivers are implemented as locking plates mounted between jammer plates;
a length of the jammer plates determines a position of the locking plates within their respective one of the first elongated slots and the second elongated slots;
the first clevis assemblies are configured to interface with the locking plates mounted in the first elongated slots; and
the second clevis assemblies are configured to interface with the locking plates mounted in the second elongated slots.

11. The aircraft passenger seat assembly according to claim 10, wherein at least some of the first and second clevis assemblies includes a riser.

12. An aircraft passenger seat assembly, comprising:
a base subassembly configured to mount to a floor in an aircraft cabin;
a frame subassembly mounted on the base subassembly; and
a seat subassembly movably mounted to the frame subassembly;
wherein the frame subassembly and the base subassembly interface through receivers that are position adjustable to change an angle of the frame subassembly relative to the base subassembly.

13. The aircraft passenger seat assembly according to claim 12, wherein:
the receivers comprise spacer frames translatably mounted to the base subassembly; and
the frame subassembly includes spreaders configured to mount to the spacer frames.

14. The aircraft passenger seat assembly according to claim 12, wherein the spacer frames are symmetrical and are symmetrically arranged on the base subassembly such that the frame subassembly can be mounted on the base subassembly in a forward facing orientation or an aft facing orientation.

15. The aircraft passenger seat assembly according to claim 12, wherein:
the base subassembly is a plinth;
the receivers comprise locking plates disposed in elongated slots formed in the plinth; and
the frame subassembly comprises clevis assemblies configured to mount to the locking plates.

16. The aircraft passenger seat assembly according to claim 15, wherein each locking plate is constrained between two jammers, and wherein a length of each of the two jammers determines a position of each locking plate relative to its respective elongated slot.

17. The aircraft passenger seat assembly according to claim 15, wherein the clevis assemblies are height adjustable.

18. An aircraft passenger seat assembly, comprising:
a base subassembly; and
a frame subassembly mounted to the base subassembly;
wherein the frame subassembly interfaces with the base subassembly through position adjustable receivers on the base subassembly; and
wherein a position of the receivers is configured to be set at installation of the passenger seat assembly in an aircraft and is not dynamically adjustable during use of the passenger seat assembly.

19. The aircraft passenger seat assembly according to claim 18, wherein the receivers interface with first and second spreaders of the frame subassembly.

20. The aircraft passenger seat assembly according to claim 18, wherein the receivers comprise position adjustable spacer frames translatably mounted to the base subassembly or position adjustable locking plates mounted in elongated slots formed in the base subassembly.
